(19) United States
(12) Patent Application Publication
(10) Pub. No.: US 2022/0048051 A1
(43) Pub. Date: Feb. 17, 2022

(54) Helical Nozzle

(71) Applicant: Medtronic, Inc., Minneapolis, MN (US)

(72) Inventor: Samuel M Eggers, Minneapolis, MN (US)

(73) Assignee: Medtronic, Inc., Minneapolis, MN (US)

(21) Appl. No.: 17/399,265

(22) Filed: Aug. 11, 2021

Related U.S. Application Data
(60) Provisional application No. 63/066,672, filed on Aug. 17, 2020.

(51) Int. Cl. B05B 1/34; B01F 1/00; B01F 5/02

(52) U.S. Cl. CPC B05B 1/3405; B01F 1/0022; B01F 2005/0017; B01F 1/0005; B01F 5/0231

(57) ABSTRACT

The disclosure relates to devices, systems, and methods using a helical nozzle. The devices, systems, and methods can include a helical nozzle having a plurality of flow channels that rotate around a center axis of the nozzle. The rotated channels can impart a helical flow to fluid moving through the nozzle thereby speeding dissolution of material within a container connected to the nozzle.

### CROSS REFERENCE

This application claims priority to Provisional Application No. 63/066,672, filed Aug. 17, 2020, the entire contents of which are hereby incorporated by reference.

### FIELD

The disclosure relates to devices, systems, and methods for a helical nozzle. The helical nozzle can include a plurality of flow channels that rotate around a center axis of the nozzle to impart a helical flow on fluid moving through the nozzle and then into a receiving chamber of the fluid leaving the nozzle.

### BACKGROUND

Nozzles for dissolving a solid substance such as a powder or for mixing a fluid inside a container oftentimes induce a swirling action of an introduced flow stream to an interior of the container. However, depending on the type of powder or fluid initially contained inside the container, current systems and methods often fail to provide the necessary dissolution within a certain time or within certain environmental specifications such as temperature or pressure. The known systems and methods may also physically agitate the solution to provide suitable mixing of the solid components using mechanical means such as stir bars that may not be suitable in clinical settings due to vibration, cost, or engineering limitations. Moreover, the known systems and methods may use complex flow design or expensive configurations that may not be suitable for certain applications or fail to provide adequate mixing. One area in which adequate dissolution may be lacking is for on-line generation of dialysate from a solid substance such as powder. The known systems attempt to mix concentrate powders or solutions to generate a fluid suitable for hemodialysis or peritoneal dialysis. Dialysis systems can require one or more solid substances, concentrate solutions, or combinations thereof that are mixed to generate a dialysate solution. The concentrate solutions are generally made by dissolving solid material in water or by further diluting a concentrate. However, solid substances such as one or more powders that are initially contained in a pouch or container can be difficult to dissolve, particularly if the powder has settled or hardened over time, or has a specific density or compaction. The formation of concentrates by adding water and agitating the solution can therefore take additional time, thereby increasing set-up time, reducing the clinical treatment time, and increasing costs. Further, the known systems and methods may fail to provide adequate mixing of the dissolved solids under certain conditions, or further dilution of the concentrates, to form completely homogeneous mixtures that restricts clinical utility of the formed mixture.

As such, there is a need for systems and methods for dissolving substances or diluting concentrates to form homogenous concentrated solutions under a certain time restrictions and environmental conditions. The need extends to systems and methods for full dissolution of material(s) without the need for stir bars or other external means of agitating the solution. There is a further need for systems and methods that generate a helical flow when fluid is added to a container, speeding dissolution of the solid material within the container. The induced spiraling or swirling action must be suitable for the desired application. The need extends beyond systems just for dialysis and should be applicable to any field requiring adequate mixing under specified conditions and time limits.

### SUMMARY OF THE INVENTION

The first aspect of the invention relates to a nozzle. In any embodiment, the nozzle can have a nozzle housing having a starting end and a terminal end, wherein the starting end is fluidly connectable to a fluid line, a number of flow channels inside the nozzle housing wherein the flow channels traverse the nozzle housing from an inlet port to an outlet port, wherein the inlet port is in fluid communication with the starting end and the outlet port is in fluid communication with the terminal end, and each flow channel rotating about a center axis of the nozzle housing from the inlet port to the outlet port, wherein an angle of difference between the inlet port and outlet port from a top perspective ranges from 20° to 70° about the center axis of the nozzle housing.

In any embodiment, the terminal end of the nozzle housing can have a hemispherical dome having one or more elevations about a circumference of the hemispherical dome, wherein two or more outlet ports can be positioned at one or more elevations on the hemispherical dome.

In any embodiment, the terminal end of the nozzle housing can have a substantially flat surface wherein the two or more outlet ports can be positioned on the substantially flat surface.

In any embodiment, the number of flow channels can range from two to twelve.

In any embodiment, the flow channels can rotate about a center axis of the nozzle housing from the inlet port to the outlet port and can be curved to form a helical flow channel.

In any embodiment, the nozzle housing can define an inner tubular flow path from the starting end to the one or more inlet ports of the flow channels.

In any embodiment, the nozzle housing can define a first inner tubular flow and a concentric second inner tubular flow path distal to the first tubular flow path, wherein the diameter of the second inner tubular flow path is smaller than the first inner tubular flow path.

In any embodiment, the nozzle housing can also have a connector for fluid connection to the starting end of the nozzle housing.

In any embodiment, the connector can be threaded on an exterior or interior surface.

In any embodiment, the nozzle housing can have outlet ports on the terminal end that are positioned equidistant from the center axis of the nozzle housing.

In any embodiment, at least two of the outlet ports can be positioned at different distances from the center axis of the nozzle housing.

The features disclosed as being part of the first aspect of the invention can be in the first aspect of the invention, either alone or in combination, or follow any arrangement or permutation of any one or more of the described elements. Similarly, any features disclosed as being part of the first aspect of the invention can be in a second or a third aspect of the invention described below, either alone or in combination, or follow any arrangement or permutation of any one or more of the described elements.

The second aspect of the invention relates to a system. In any embodiment, the system can have a flow path fluidly connected to a water source, a fluid line fluidly connecting the starting end of the nozzle housing of the first aspect of the invention to the flow path, and a concentrate source fluidly connected to the nozzle housing.

In any embodiment, the concentrate source can contain a solid.

In any embodiment, the flow path from the nozzle housing can be further fluidly connected to a dialysate container.

In any embodiment, the flow path can be a peritoneal dialysate generation flow path.

In any embodiment, the concentrate source can be selected from solid glucose, solid bicarbonate, solid sodium chloride, solid potassium chloride, solid magnesium chloride, solid calcium chloride, lactic acid, and combinations thereof.

In any embodiment, one or more nozzles of claim can be affixed to a bottom surface of a container containing one or more concentrate source.

The features disclosed as being part of the second aspect of the invention can be in the second aspect of the invention, either alone or in combination, or follow any arrangement or permutation of any one or more of the described elements. Similarly, any features disclosed as being part of the second aspect of the invention can be in the first aspect or a third aspect of the invention described below, either alone or in combination, or follow any arrangement or permutation of any one or more of the described elements.

The third aspect of the invention relates to a method. In any embodiment, the method can have the steps of pumping water from the water source through the starting end of the nozzle housing into the concentrate source; dissolving a solid or powdered substance in the concentrate source to generate a concentrate or diluting a concentrate to a new concentration; and pumping the concentrate into the flow path.

In any embodiment, the flow path can be part of a dialysis flow path.

In any embodiment, the flow path can be part of a peritoneal dialysis flow path.

In any embodiment, the concentrate source can be selected from solid glucose, solid bicarbonate, solid sodium chloride, solid potassium chloride, solid magnesium chloride, solid calcium chloride, lactic acid, and combinations thereof.

In any embodiment, the method can include the step of pumping one or more concentrates from one or more ion concentrate sources to the flow path to generate a peritoneal dialysate.

The features disclosed as being part of the third aspect of the invention can be in the third aspect of the invention, either alone or in combination, or follow any arrangement or permutation of any one or more of the described elements. Similarly, any features disclosed as being part of the third aspect of the invention can be in the first or second aspect of the invention, either alone or in combination, or follow any arrangement or permutation of any one or more of the described elements. The features disclosed as being part of the first, second, or third aspect of the invention can be in the first, second, or third aspect of the invention, either alone or in combination, or follow any arrangement or permutation of any one or more of the described elements. Similarly, any features disclosed as being part of the first or third aspect of the invention can be in the second aspect of the invention, either alone or in combination, or follow any arrangement or permutation of any one or more of the described elements.

### BRIEF DESCRIPTION OF THE DRAWINGS

FIGS. 1A-D illustrate a nozzle having eight outlet ports and a flat top.

FIGS. 2A-D illustrate a nozzle having eight outlet ports and a domed top.

FIGS. 3A-C illustrate a nozzle having four outlet ports.

FIGS. 4A-E illustrate a nozzle having eight outlet ports and a domed top, with the outlet ports positioned at different distances from a center axis of the nozzle.

FIGS. 5A-C illustrate a nozzle having eight outlet ports and a flat top, with the outlet ports positioned at different distances from a center axis of the nozzle.

FIG. 6 illustrates a container for connection to the nozzles described herein.

FIG. 7 is a non-limiting embodiment of a peritoneal dialysate generation flow path.

FIG. 8 illustrates velocity distribution of fluid flow through a container using a helical nozzle.

FIG. 9 shows a side view of a temperature distribution diagram for fluid flow through a container using a helical nozzle.

FIG. 10 shows a cross-sectional view of a temperature distribution diagram for fluid flow through a container using a helical nozzle.

FIG. 11 shows a top view of a temperature distribution diagram for fluid flow through a container using a helical nozzle.

### DETAILED DESCRIPTION

Unless defined otherwise, all technical and scientific terms used have the same meaning as commonly understood by one of ordinary skill in the art.

The articles “a” and “an” are used to refer to one to over one (i.e., to at least one) of the grammatical object of the article. For example, “an element” means one element or over one element.

The term “affixed” means fastened or joined by any means. The component being affixed to a surface can be reversibly attached and detached. By affixing, the component being affixed can function as intended. For example, a nozzle affixed to a bottom surface can provide fluid to flow through the nozzle while being reversibly affixed to the bottom surface.

The term “angle of difference” refers to the difference between two points on a circumference of a circle as measured between the two points. For example, a point at 10° and a point at 30° has an angle of difference of 20°, while a point at 30° and a point at 100° has an angle of difference of 70°.

The term “around a circumference” refers to a position of components around an outer edge of a circle.

The term “bicarbonate” refers to carbonate anions, CO₂⁻, either in solution or as a salt with any counter ion.

The term “bottom” refers to a lower part of a component or feature commonly used to support the component or feature.

“Calcium chloride” refers to CaCl₂, either in solution or solid form

The term “center axis” refers to an imaginary line directly through the middle of a component or position.

The term “comprising” includes, but is not limited to, whatever follows the word “comprising.” Use of the term indicates the listed elements are required or mandatory but that other elements are optional and may be present.

A “concentrate” is a solution of one or more solutes in water. The concentrate can have a solute concentration greater than that to be used in dialysis

The term “concentrate source” refers to any container or component from which a concentrated solution can be obtained, including by dissolution of solids, or further dilution of a concentrate.

The term “concentric” refers to two or more circles sharing the same center point.

The term “connector” refers to any component that can join two other components.

The term “consisting of” includes and is limited to whatever follows the phrase “consisting of.” The phrase indicates the limited elements are required or mandatory and that no other elements may be present.

The term “consisting essentially of” includes whatever follows the term “consisting essentially of” and additional elements, structures, acts or features that do not affect the basic operation of the apparatus, structure or method described.

The terms “contain” or “containing” refer to a material held within a component or container. The term contain is open ended and does not prevent the inclusion of other components being included within the same component.

A “container” is any component that can hold a solid, liquid, solution, or combinations thereof.

The term “curved” refers to a shape that is not a straight line.

The term “dialysate container” refers to a container that can hold dialysate until the dialysate is needed for treatment.

The term “dialysis flow path” refers to any portion of a fluid pathway that conveys a dialysate and is configured to form at least part of a fluid circuit for hemodialysis, hemofiltration, ultrafiltration, hemodiafiltration or ultrafiltration. Optionally, the fluid pathway can contain priming fluid during a priming step or cleaning fluid during a cleaning step.

The term “diameter” refers to a distance of a line from one side of a circle, through the center of the circle, to the other side of the circle.

The term “different distances” refers to the relative positions of two components, one of which is further away than the other from a reference point.

The term “diluting” or to “dilute” refer to lowering a concentration of a solute in solution by adding solvent.

The term “dissolving” or to “dissolve” refers to the formation of a solution from a liquid solvent and a solute.

The term “distance” refers to a length of space between two points.

The term “elevation” refers to a height of a point above a base of a component.

The term “equidistant” refers to the relative positions of two components that are the same distance from some reference point.

The term “exterior” refers to a portion of a component that is outside the walls or housing of the component.

A “flow channel” or “channel” can be a conduit or passageway through which a fluid, gas, or combinations thereof can travel.

The term “flow path” can refer to a fluid pathway or passageway that conveys a fluid, gas, or combinations thereof.

A “fluid line” can refer to a tubing or conduit through which a fluid, gas, or a combination thereof can pass. The fluid line can also contain air during different modes of operation such as cleaning or purging of a path or line.

The term “fluidly connectable” refers to the ability to provide passage of fluid, gas, or combinations thereof, from one point to another point. The ability to provide such passage can be any mechanical connection, fastening, or forming between two points to permit the flow of fluid, gas, or combinations thereof. The two points can be within or between any one or more of compartments, modules, systems, components, and rechargers, all of any type. Notably, the components that are fluidly connectable, need not be a part of a structure. For example, an outlet “fluidly connectable” to a gas removal pump does not require the gas removal pump, but merely that the outlet has the features necessary for fluid connection to the gas removal pump.

The term “fluidly connected” refers to a particular state or configuration of one or more components such that fluid, gas, or combination thereof, can flow from one point to another point. The connection state can also include an optional unconnected state or configuration, such that the two points are disconnected from each other to discontinue flow. It will be further understood that the two “fluidly connectable” points, as defined above, can from a “fluidly connected” state. The two points can be within or between any one or more of compartments, modules, systems, components, and rechargers, all of any type.

The phrases “to generate a dialysate” or “dialysate generation” refer to creating a dialysate solution from constituent parts.

The phrases “to generate peritoneal dialysate” or “peritoneal dialysate generation” refer to creating a peritoneal dialysate solution from constituent parts.

The term “glucose” refers to a crystalline sugar, also called dextrose. Glucose is one of a group of carbohydrates known as simple sugars (monosaccharides) having the molecular formula C₆H₁₂O₆.

The terms “helical” and “helical flow” can refer to a spiraling or swirling flow direction having a spiral or swirling movement around an axis in a direction of flow.

A “hemispherical dome” refers to a shape of an outer edge of a component that is substantially round, forming a half portion of a sphere. The hemispherical dome need not be exactly half the sphere but can be around half. The size and exact shape can vary as required and contemplated by the invention.

A “inlet port” is a portion of a component through which gas, fluid, and combinations thereof can enter or exit the component. Although the term inlet port generally refers to an opening for entry of gas, fluid, and combinations thereof, the inlet can sometimes provide a means for exiting or exhausting the gas, fluid, and combinations thereof. For example, during a priming, cleaning, or disinfection, the inlet can be used to remove gas, fluid, and combinations thereof through the inlet. Also, during operation, the inlet port can remove gas, fluid, and combinations thereof.

The term “inner” refers to an interior portion of a component.

The term “interior” refers to a portion of a component that is inside walls or housing of the component.

The term “ion concentrate” refers to one or more ionic compounds dissolved in solution. The ion concentrate can have an ion concentration greater than an ion concentration to be used in dialysis.

An “ion concentrate source” refers to a source of one or more ionic compounds. The ion concentrate source can be in solution or solid form. The ion concentrate source can further have one or more ionic compounds that are at a higher ion concentration greater than generally used in dialysis, including but not limited to buffer sources, pH sources, ionic sources, and combinations thereof.

“Lactic acid” refers to C₃H₆O₃, either in solution or solid form.

“Magnesium chloride” refers to MgCl₂, either in solution or solid form.

A “nozzle” is a component through which fluid moves from one fluid line, container, or component into a second fluid line, container, or component.

The term “nozzle housing” refers to the outer portion of a nozzle through which fluid does not flow.

An “outlet port” is a portion of a component through which gas, fluid, and combinations thereof can enter or exit the component. Although the term outlet port generally refers to an opening for exit of gas, fluid, and combinations thereof, the outlet port can sometimes provide a means of entrance for the gas, fluid, and combinations thereof. For example, during a priming, cleaning, or disinfection, the outlet port can allow gas, fluid, and combinations thereof to enter the component through the outlet port. Also, during operation, the outlet port can allow entry of gas, fluid, and combinations thereof.

“Peritoneal dialysate” is a dialysis solution to be used in peritoneal dialysis having specified parameters for purity and sterility. Peritoneal dialysate is not the same as dialysate used in hemodialysis although peritoneal dialysate may be used in hemodialysis.

A “peritoneal dialysis flow path” is a path used in generating dialysate suitable for peritoneal dialysis.

The terms “positioned” or “position” refer to a component connected to or in contact relative to the feature being referred to. The contact can be physical, fluid, or electrical and is intended to be used in the broadest reasonable interpretation.

“Potassium chloride” refers to KCl, either in solution or solid form.

The terms “pumping” or to “pump” refer to moving a fluid through a flow path with a pump.

The term “radially” refers to an arrangement of components characterized by a divergence in position around a center of a second component.

The term “rotates” or to “rotate” refers to the movement of a component in a circular direction. The rotation need not be limited to a single plane and can describe an advancing screw like tracing motion or path.

The phrases “rotates around a center axis” or to “rotate around a center axis” refer to a flow path, conduit, or channel that moves in a spiral around an axis straight through a center of a component. The rotation need not be limited to a single plane and can describe an advancing screw like tracing motion or path.

“Sodium chloride” refers to NaCl, either in solution or solid form.

The term “solid” refers to a material in the solid phase of matter, and can include crystalline, powdered, or any other form of solid material.

The term “starting end” refers to an end of a component through which fluid or gas can pass. The term “starting end” does not imply that fluid can flow in only a single direction through into or out of the component, but is used only to distinguish one end from a different end.

The term “substantially flat surface” refers to a shape of an outer edge of a component, wherein the outer edge of the component does not significantly change in elevation at any point.

The term “terminal end” refers to an end of a component through which fluid or gas can pass. The term “terminal end” does not imply that fluid can flow in only a single direction through into or out of the component, but is used only to distinguish one end from a different end.

The term “threaded” refers to a helical structure wrapped around a component to allow engagement with another component.

The term “top perspective” refers to a view of a component from above the component when the component is placed in an orientation for normal use.

The term “top portion” refers to a portion of a component that is generally positioned on the high end of the component during normal use.

The term “traverse” refers to crossing from one point to another point.

The term “tubular” refers to a substantially round conduit.

A “water source” can be a fluid source from which water can be stored, obtained, or delivered therefrom.

### Helical Nozzle

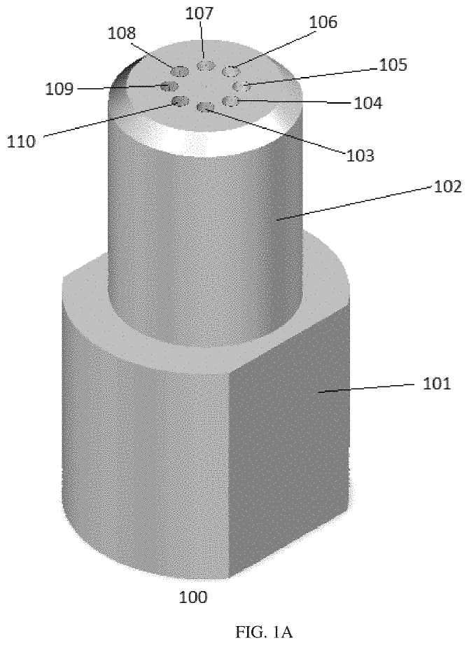

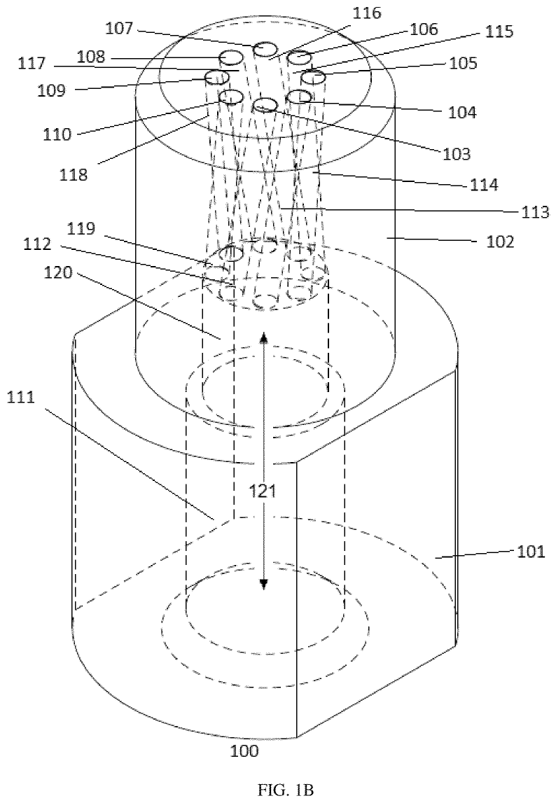

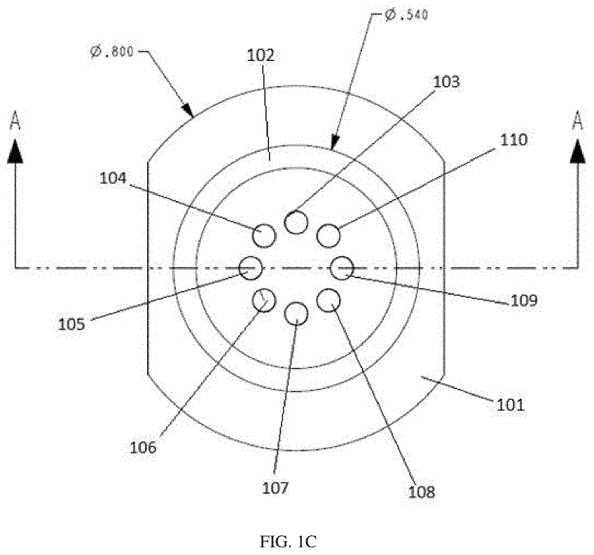

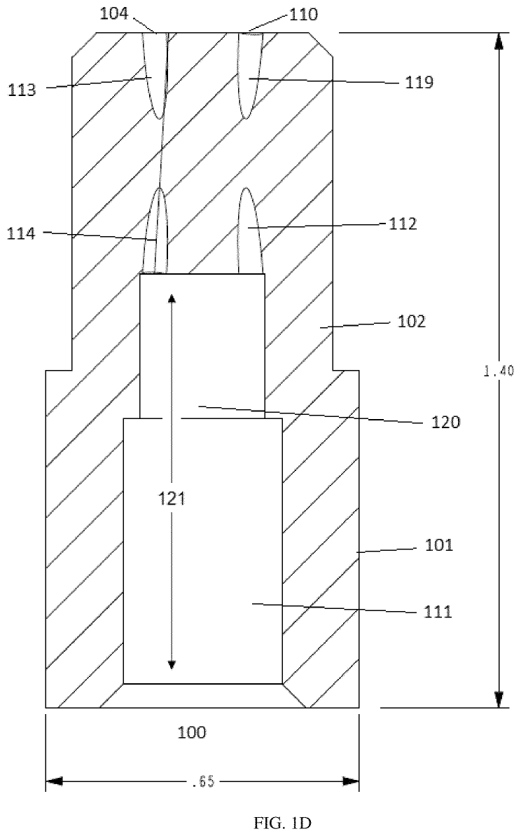

FIG.'s 1A-D illustrate a non-limiting embodiment of a nozzle 100 having helical flow channels inside the nozzle 100. FIG. 1A illustrates an exterior view of the nozzle 100, FIG. 1B is a transparent view of the nozzle 100, FIG. 1C is a top view of the nozzle 100, and FIG. 1D is a cross section of the nozzle 100.

The nozzle 100 can have a starting end at a bottom portion 101 at a base of the nozzle 100. The nozzle 100 can have a terminal end at a top portion 102 of the nozzle 100. The top portion 102 of the nozzle 100 can have a smaller diameter than the bottom portion 101. In other embodiments, the top portion 102 and bottom portion 101 can have the same size, depending on the needs of the system and user. The starting end at the bottom portion 101 at the base of the nozzle 100 can be connected to a container (not shown) to introduce fluid into or withdraw fluid from the container. The starting end at a bottom portion 101 of the nozzle 100 can connect to a fluid line (not shown). The terminal end at the top portion 102 of the nozzle 100 can be a substantially flat surface. However, as described, the terminal end can have other shapes, such as a hemispherical dome or a rectangular shape. As illustrated in FIGS. 1A-C, the nozzle 100 can include a plurality of fluid outlet port 103, fluid outlet port 104, fluid outlet port 105, fluid outlet port 106, fluid outlet port 107, fluid outlet port 108, fluid outlet port 109, and fluid outlet port 110. Each of the fluid outlet port 103, fluid outlet port 104, fluid outlet port 105, fluid outlet port 106, fluid outlet port 107, fluid outlet port 108, fluid outlet port 109 in the terminal end of the nozzle 100 can be connected to one of a plurality of respective flow channel 112, flow channel 113, flow channel 114, flow channel 115, flow channel 116, flow channel 117, flow channel 118, and flow channel 119.

As shown in FIG. 1B and FIG. 1D, each of the flow channel 112, flow channel 113, flow channel 114, flow channel 115, flow channel 116, flow channel 117, flow channel 118, and flow channel 119 traverse the nozzle 100 from an inlet port to fluid outlet port 103, fluid outlet port 104, fluid outlet port 105, fluid outlet port 106, fluid outlet port 107, fluid outlet port 108, fluid outlet port 109, and fluid outlet port 110.

The plurality of flow channel 112, flow channel 113, flow channel 114, flow channel 115, flow channel 116, flow channel 117, flow channel 118, and flow channel 119 can be in fluid communication with a second tubular flow path 120 of an inner tubular flow path 121 within the top potion 102 of the nozzle 100. The second tubular flow path 120 can have a larger diameter than any one of flow channel 112, flow channel 113, flow channel 114, flow channel 115, flow channel 116, flow channel 117, flow channel 118, and flow channel 119. A larger diameter first tubular flow path 111 of the inner tubular flow path 121 can be concentric and fluidly connect to an inlet port of the nozzle 100 in the bottom portion 101. The first tubular flow path 111 and second tubular flow path 120 can be concentric, with the second tubular flow path 120 distal to the first tubular flow path 111, forming the larger inner tubular flow path 121. The nozzle housing can define an interior tubular flow path 121 from the starting end of the nozzle housing to the inlet ports of the flow channel 112, flow channel 113, flow channel 114, flow channel 115, flow channel 116, flow channel 117, flow channel 118, and flow channel 119.

As illustrated in FIG. 1B, each of the flow channel 112, flow channel 113, flow channel 114, flow channel 115, flow channel 116, flow channel 117, flow channel 118, and flow channel 119 rotate around a center axis of the nozzle 100, forming a helical screw-like flow that advances along the nozzle 100. The rotation of the flow channel 112, flow channel 113, flow channel 114, flow channel 115, flow channel 116, flow channel 117, flow channel 118, and flow channel 119 can impart or induce a helical or swirling flow on fluid moving through the nozzle 100. The helical flow creates a swirling action within a container when a fluid exits inlet port to fluid outlet port 103, fluid outlet port 104, fluid outlet port 105, fluid outlet port 106, fluid outlet port 107, fluid outlet port 108, fluid outlet port 109, and fluid outlet port 110. The swirling action can induce a mixing action similar to a stir bar to improve dissolution of solid material within the container. The mixing action can reduce mixing time for dissolving any material initially contained within the container. For example, in certain applications dissolution, that can take from thirty minutes to several hours without the nozzle of the invention can be reduced to 10-15 minutes, depending on the concentrate being generated. The swirling action formed by the helical flow can reduce or eliminate the need for mechanical components such as a stir bar inside the containers, or flow paths that attempt to disperse fluid at the top of the container. The present invention can also improve the mixing of different fluids to achieve a homogeneous solution more rapidly when further diluting a first concentrate to a new concentration, or when mixing various fluids together. The present invention can also be used for pH mixing when raising or lowering the pH of a fluid.

The difference in angle between an inlet and an outlet from any one of the flow channel 112, flow channel 113, flow channel 114, flow channel 115, flow channel 116, flow channel 117, flow channel 118, and flow channel 119 as viewed from the top perspective can describe the rotation of the fluid flow within the channels. For example, each of the flow channel 112, flow channel 113, flow channel 114, flow channel 115, flow channel 116, flow channel 117, flow channel 118, and flow channel 119 defines a flow path that starts from an inlet in fluid communication with the second tubular flow path 120 as shown in FIG. 1B. Viewed from a top perspective, the inlet and outlet of any one of the flow channel 112, flow channel 113, flow channel 114, flow channel 115, flow channel 116, flow channel 117, flow channel 118, and flow channel 119 can rotate between about 20° to about 70° around the center axis of the nozzle 100. The angle of difference between the inlet and outlet when viewed from the top perspective can also range from about 20° to about 30°, about 20° to about 40° about 20° to about 50° about 20° to about 60° about 20° to about 63°. In specific embodiments, the angle of difference between the inlet and outlet when viewed from a top perspective can be any one of 20°, 30°, 35°, 45°, 50°, 55°, 60°, or 65°.

As illustrated in FIG. 1C, the nozzle 100 has fluid outlet port 103, fluid outlet port 104, fluid outlet port 105, fluid outlet port 106, fluid outlet port 107, fluid outlet port 108, fluid outlet port 109, and fluid outlet port 110. The nozzle 100 is not limited to having eight outlet ports as shown in FIG. 1C, and can have any number of outlet ports capable of inducing a spiraling or swirling flow, including 2, 3, 4, 5, 6, 7, 9, 10, 11, 12 or more outlets. The number and size of the ports is only dependent upon the desired diameter of the outlet ports and the diameter of the top portion 102 of the nozzle 100. Although shown as having all fluid outlet port 103, fluid outlet port 104, fluid outlet port 105, fluid outlet port 106, fluid outlet port 107, fluid outlet port 108, fluid outlet port 109, and fluid outlet port 110 being equidistant from a center of the top portion 102 of the nozzle 100, any spacing or arrangement of outlet ports is contemplated. For example, the outlet ports can be arranged in one or more concentric circles about a center axis when viewed from a top perspective. Alternatively, each of the outlet ports can be spaced at a different distance from the center axis. Any arrangement of outlet ports on the top portion 102 of the nozzle 100 can be used. The distance between the fluid outlet port 103, fluid outlet port 104, fluid outlet port 105, fluid outlet port 106, fluid outlet port 107, fluid outlet port 108, fluid outlet port 109, and fluid outlet port 110 and the center axis can depend on the size of the nozzle 100. To maintain a desired aspect ratio for the nozzle, the distance between the fluid outlet port 103, fluid outlet port 104, fluid outlet port 105, fluid outlet port 106, fluid outlet port 107, fluid outlet port 108, fluid outlet port 109, and fluid outlet port 110 and the center axis can be proportional to the size of the nozzle 100.

The size of the fluid outlet port 103, fluid outlet port 104, fluid outlet port 105, fluid outlet port 106, fluid outlet port 107, fluid outlet port 108, fluid outlet port 109, and fluid outlet port 110 can be set at any size that fits on the top portion 102 of the nozzle. Due to fluid viscosity, better mixing can be achieved in certain embodiments with a smaller diameter fluid for the outlet port 103, fluid outlet port 104, fluid outlet port 105, fluid outlet port 106, fluid outlet port 107, fluid outlet port 108, fluid outlet port 109, and fluid outlet port 110. For example, a nozzle 100 having eight outlet ports can use an outlet diameter of about 0.050 inches. However, the outlet diameter can be between any size from a fraction of a millimeter to several centimeters. As illustrated in FIG. 1C, the top portion 102 of the nozzle 100 can have a diameter of 0.540 inches, while a larger bottom portion 101 can form part of a circle having a diameter of about 0.800 inches. In certain embodiments, the bottom portion 101 can be any shape, including but not limited to round, rectangular, square, oval, or irregular. As illustrated, in FIG. 1D, the height of the nozzle 100 can be about 1.40 inches, while the width of the bottom portion 101 can be about 0.85 inches. However, other sizes can be used for the nozzle 100, depending on the size of the containers used and the needs of the user.

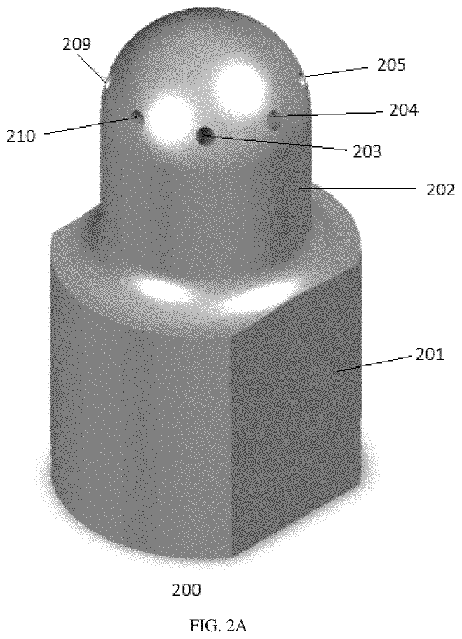

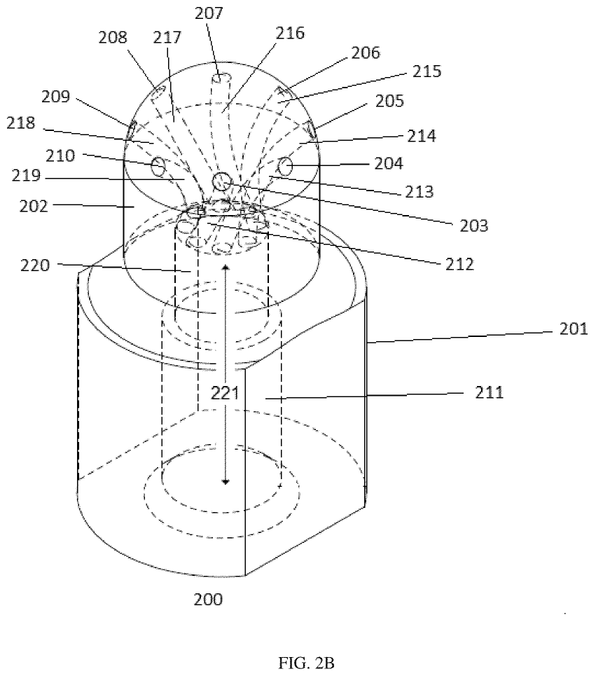

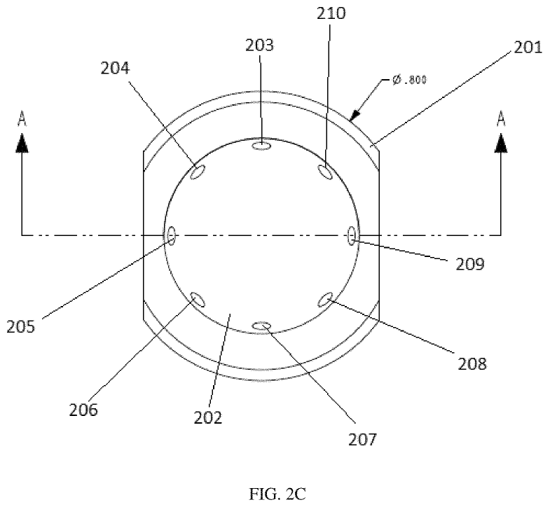

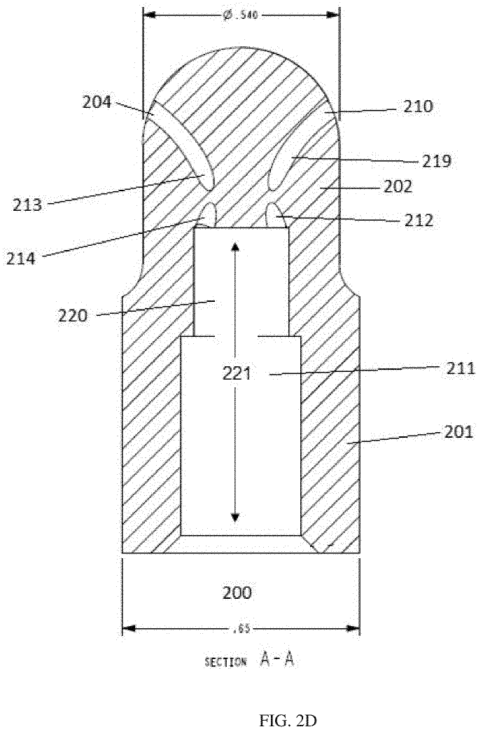

FIG. 2A illustrates an exterior view of a nozzle 200. FIG. 2B is a transparent view of the nozzle 200. FIG. 2C is a top view of the nozzle 200. FIG. 2D is a cross section of the nozzle 200. The nozzle 200 can have a dome shaped top portion 202. As shown in FIG. 2B, the nozzle 200 can have fluid flow channel 212, fluid flow channel 213, fluid flow channel 214, fluid flow channel 215, fluid flow channel 216, fluid flow channel 217, fluid flow channel 218, and fluid flow channel 219. Each channel can traverse the nozzle 200 from inlet ports to fluid outlet port 203, fluid outlet port 204, fluid outlet port 205, fluid outlet port 206, fluid outlet port 207, fluid outlet port 208, fluid outlet port 209, and fluid outlet port 210 positioned at a terminal end of the nozzle 200 at the dome shaped top portion 202. The flow channel 212, flow channel 213, flow channel 214, flow channel 215, flow channel 216, flow channel 217, flow channel 218, and flow channel 219 can rotate about a center axis of the nozzle 200 to impart a helical or swirling flow onto fluid moving through the nozzle 200. The nozzle 200 can include a bottom portion 201, wherein the top portion 202 has a smaller interior diameter than the bottom portion 201. Fluid can enter the nozzle 200 through a fluid inlet at the starting end of the nozzle 200 in fluid communication with a first tubular flow path 211. The first tubular flow path 211 is distal to concentric second tubular flow path 220, forming an inner tubular flow path 221. From inner tubular flow path 221, fluid can enter the smaller flow channel 212, flow channel 213, flow channel 214, flow channel 215, flow channel 216, flow channel 217, flow channel 218, and flow channel 219 before exiting through the respective outlet port 203, outlet port 204, outlet port 205, outlet port 206, outlet port 207, outlet port 208, outlet port 209, and outlet port 210 at the terminal end of the nozzle 200.

The terminal end of the nozzle 200 has a hemispherical dome shape, which causes the outlet port 203, outlet port 204, outlet port 205, outlet port 206, outlet port 207, outlet port 208, outlet port 209, and outlet port 210 to be pushed further out to the side of the nozzle 200. The outlet port 203, outlet port 204, outlet port 205, outlet port 206, outlet port 207, outlet port 208, outlet port 209, and outlet port 210 at the terminal end of the nozzle 200 can be all at the same elevation. However, in certain embodiments, the outlet ports can be positioned at one or more elevations on the dome shaped top portion 202. Further, due to the dome shape, the flow channel 212, flow channel 213, flow channel 214, flow channel 215, flow channel 216, flow channel 217, flow channel 218, and flow channel 219 can exhibit curvature in an outwardly direction in an advancing screw direction about the central axis of the nozzle 200. The dome shaped top portion 202 causes the fluid to flow more outwardly, preventing the fluid from injecting towards the top of the container. In certain embodiments, the shape of the top portion 202 can be varied to compliment the shape of the container.

The nozzle 200 of FIGS. 2A-D can have outlet port 203, outlet port 204, outlet port 205, outlet port 206, outlet port 207, outlet port 208, outlet port 209, and outlet port 210 equidistant from the center axis of the nozzle 200. However, as described, any number of outlet ports can be used, and the outlet ports need not be equidistant from the center axis. As illustrated in FIGS. 2C-2D, the top portion 202 of the nozzle 201 can have a diameter of about 0.540 inches, while the larger bottom portion 201 can form part of a circle having a diameter of about 0.800 inches. The width of the bottom portion 201 can be about 0.65 inches. However, other sizes can be used for the nozzle 200, depending on the size of the containers used and the needs of the user.

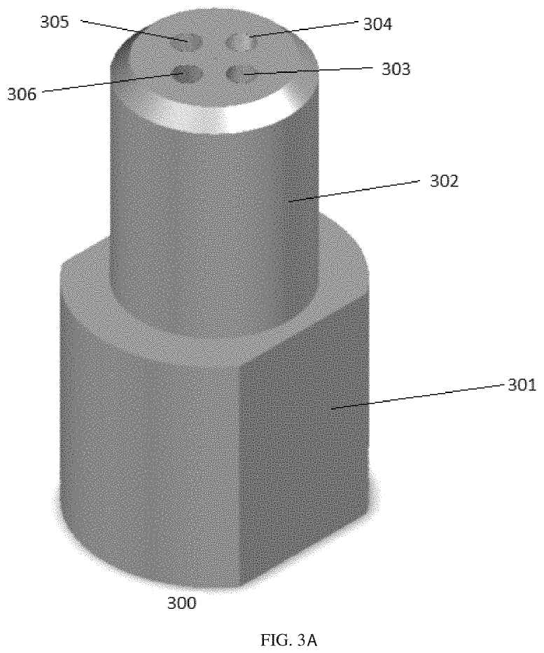

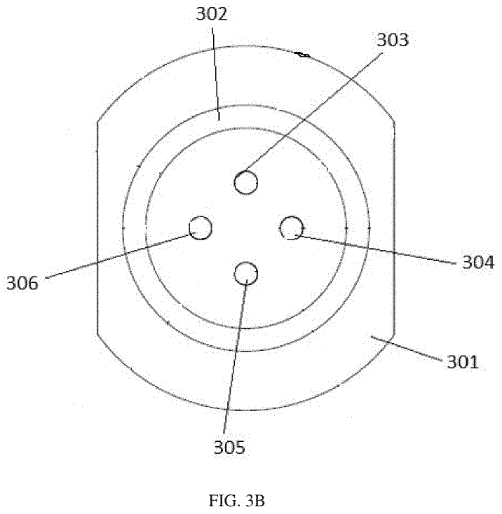

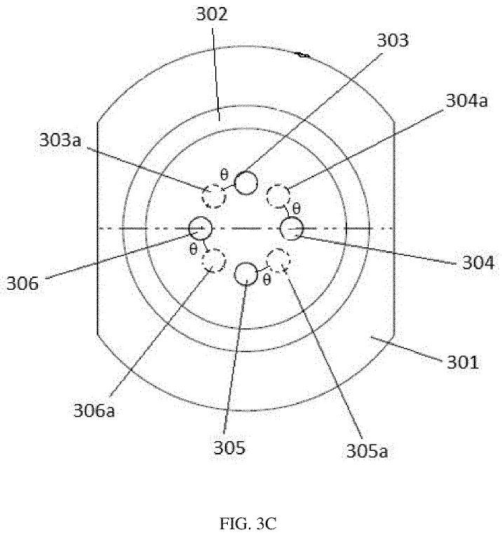

FIGS. 3A-C illustrate a nozzle 300 having outlet port 303, outlet port 304, outlet port 305, and outlet port 306. FIG. 3A illustrates an outside view of the nozzle 300, FIG. 3B illustrates a top view of the nozzle 300, and FIG. 3C illustrates a top view of the nozzle 300 showing inlets of the flow channels. The nozzle 300 can include a nozzle housing have a larger diameter bottom portion 301 and a smaller diameter top portion 302. However, as described, the nozzle housing can have a top and bottom portion that has the same diameter. A fluid line (not shown) can connect to a fluid inlet in a starting end of the bottom portion 301 of the nozzle 300, while a terminal end of the top portion 302 of the nozzle can connect to a container (not shown) to introduce or withdraw fluid from the container. The terminal end of the nozzle 300 can be a substantially flat surface, but other shapes can be used, including a hemispherical dome. The outlet port 303, outlet port 304, outlet port 305, and outlet port 306 can each connect to a flow channel (not shown) in an interior of the top portion 302 of the nozzle 300. The flow channels traverse the nozzle housing from inlet ports to outlet port 303, outlet port 304, outlet port 305, and outlet port 306. The flow channels rotate about a center axis of the nozzle 300 to impart a helical or swirling flow on the fluid exiting the nozzle 300. The interior of nozzle 300 can be similar to the interiors of nozzles 100 and 200 illustrated in FIGS. 1-2. The outlet port 303, outlet port 304, outlet port 305, and outlet port 306 can be arranged equidistant from the center axis of the nozzle 300, or the outlet port 303, outlet port 304, outlet port 305, and outlet port 306 can be positioned at different distances from the center axis. Although shown as having a flat top portion 302, the four-outlet nozzle of FIGS. 3A-C can also have a dome shaped top potion.

Each of the flow channels rotates around a center axis of the nozzle 300, illustrated as angle θ in FIG. 3C. The angle of difference between an inlet 303a, inlet 304a, inlet 305a, and inlet 306a and outlet 303, outlet 304, outlet 305, and outlet 306 of the flow channels can be between about 20° to about 70° around the center axis of the nozzle 300 from a top perspective.

The angle of difference between the inlet and outlet when viewed from the top perspective can also range from about 20° to about 30°, about 20° to about 40° about 20° to about 50° about 20° to about 60° about 20° to about 63°. In specific embodiments, the angle of difference between the inlet and outlet when viewed from a top perspective can be any one of 20°, 30°, 35°, 45°, 50°, 55°, 60°, or 65°.

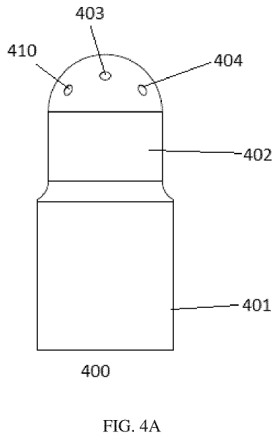

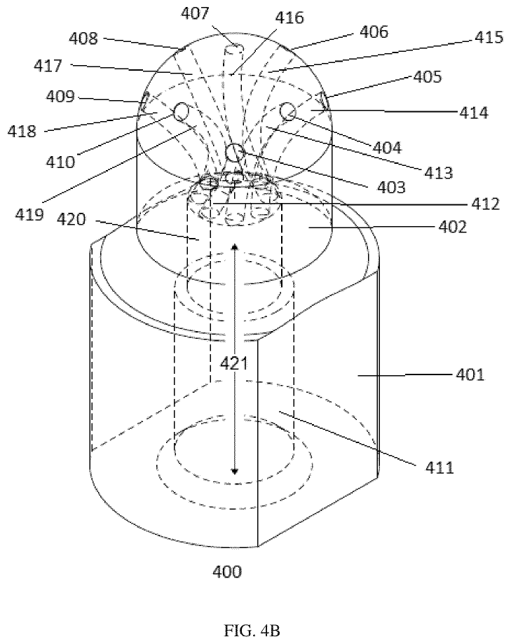

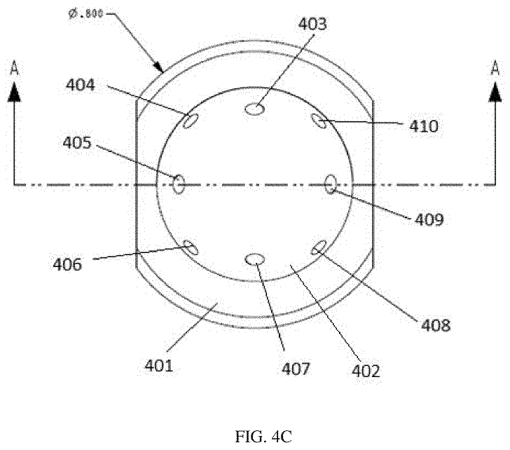

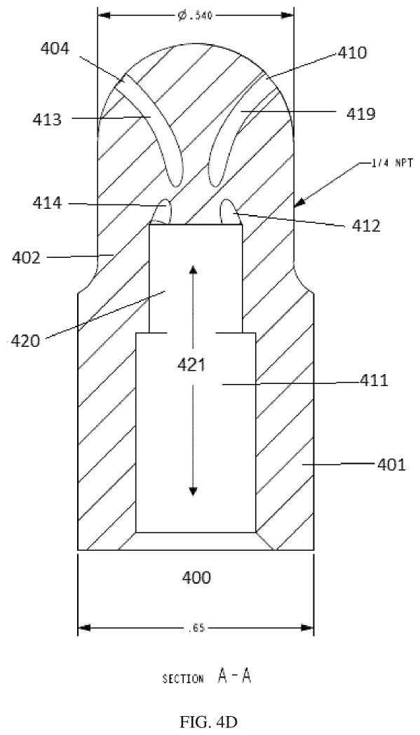

FIG. 4A illustrates an outside view of a nozzle 400, FIG. 4B is a transparent view of the nozzle 400, FIG. 4C is a top view of the nozzle 400, FIG. 4D is a cross section of the nozzle 400, and FIG. 4E is a top view of the nozzle 400 showing inlets of the flow channels. The nozzle 400 can have outlet port 403, outlet port 404, outlet port 405, outlet port 406, outlet port 407, outlet port 408, outlet port 409, and outlet port 410 each fluidly connected to one of flow channel 412, flow channel 413, flow channel 414, flow channel 415, flow channel 416, flow channel 417, flow channel 418, and flow channel 419, respectively. The flow channel 412, flow channel 413, flow channel 414, flow channel 415, flow channel 416, flow channel 417, flow channel 418, and flow channel 419 traverse the nozzle 400 from inlet ports to outlet port 403, outlet port 404, outlet port 405, outlet port 406, outlet port 407, outlet port 408, outlet port 409, and outlet port 410. The flow channel 412, flow channel 413, flow channel 414, flow channel 415, flow channel 416, flow channel 417, flow channel 418, and flow channel 419 rotate about the center axis of the nozzle 400 to induce a helical flow on fluid moving through the nozzle 400. The nozzle 400 can include a nozzle housing having a top portion 402 and a bottom portion 401, with the top portion 402 having a smaller interior diameter than the bottom portion 401. However, in any embodiment, the top portion 402 can be the same interior or exterior diameter as bottom portion 401. Fluid can enter the nozzle 400 through a fluid inlet connected to a bottom portion 401 at the starting end of the nozzle 400. The fluid can enter a larger diameter first tubular flow path 411. The first tubular flow path 411 is connected to concentric second tubular flow path 420, forming an inner tubular flow path 421. Fluid from the inner tubular flow path 421 can enter the smaller flow channel 412, flow channel 413, flow channel 414, flow channel 415, flow channel 416, flow channel 417, flow channel 418, and flow channel 419 before exiting through the outlet port 403, outlet port 404, outlet port 405, outlet port 406, outlet port 407, outlet port 408, outlet port 409, and outlet port 410at a terminal end of the nozzle 400 into a container (not shown).

The terminal end of nozzle 400 can be a hemispherical dome. The outlet port 403, outlet port 404, outlet port 405, outlet port 406, outlet port 407, outlet port 408, outlet port 409, and outlet port 410 may not be equidistant from a center axis of the nozzle 400. As illustrated in FIG. 4C, the outlet port 403, outlet port 404, outlet port 405, outlet port 406, outlet port 407, outlet port 408, outlet port 409, and outlet port 410 can be positioned at different elevations on the terminal end. In FIGS. 4A-E, the outlet port 403, outlet port 404, outlet port 405, outlet port 406, outlet port 407, outlet port 408, outlet port 409, and outlet port 410 are positioned in two concentrate circles around the center axis, with outlet ports 403, 405, 407, and 409 closer to the center axis than outlet ports 404, 406, 408, and 410. The position of the outlet port 403, outlet port 404, outlet port 405, outlet port 406, outlet port 407, outlet port 408, outlet port 409, and outlet port 410 illustrated in FIGS. 4A-E can push the vortex flow outwardly, against the container walls. Other arrangements of outlet ports around the top portion 401 of the nozzle 400 can be used, and the outlet ports need not be positioned in concentric circles.

As illustrated in FIG. 4E, each of the flow channel 412, flow channel 413, flow channel 414, flow channel 415, flow channel 416, flow channel 417, flow channel 418, and flow channel 419 can rotate around the center axis of the nozzle 400. The angle of difference between the inlet port 403a, inlet port 404a, inlet port 405a, inlet port 406a, inlet port 407a, inlet port 408a, inlet port 409a, and inlet port 410a of each flow channel and outlet port 403, outlet port 404, outlet port 405, outlet port 406, outlet port 407, outlet port 408, outlet port 409, and outlet port 410 of each flow channel can be between about 20° to about 70° around the center axis of the nozzle 400 from a top perspective. The angle of difference between the inlet and outlet when viewed from the top perspective can also range from about 20° to about 30°, about 20° to about 40° about 20° to about 50° about 20° to about 60° about 20° to about 63°. In specific embodiments, the angle of difference between the inlet and outlet when viewed from a top perspective can be any one of 20°, 30°, 35°, 45°, 50°, 55°, 60°, or 65°. As illustrated in FIG.'s 4C-4E, the top portion 402 of the nozzle 400 can have a diameter of about 0.540 inches, while the larger bottom portion 401 can form part of a circle having a diameter of about 0.800 inches. The width of the bottom portion 401 can be about 0.65 inches. However, other sizes can be used for the nozzle 400, depending on the size of the containers used and the needs of the user. The top portion 402 and bottom portion 401 can also be the same size.

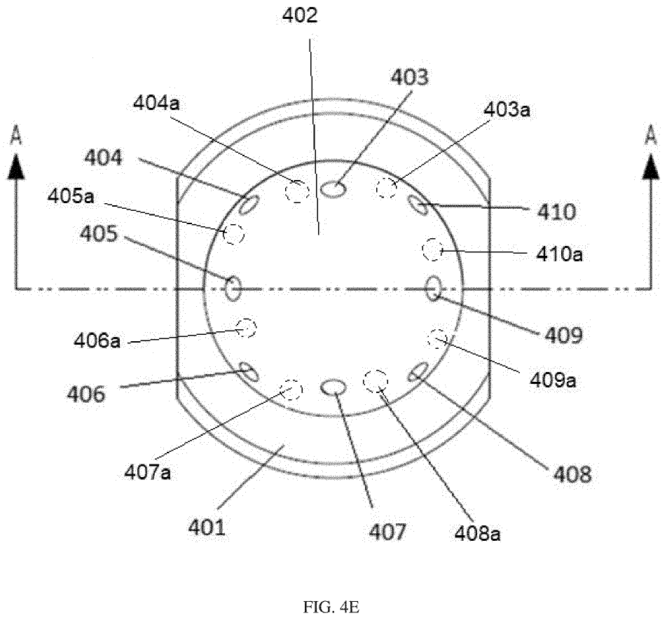

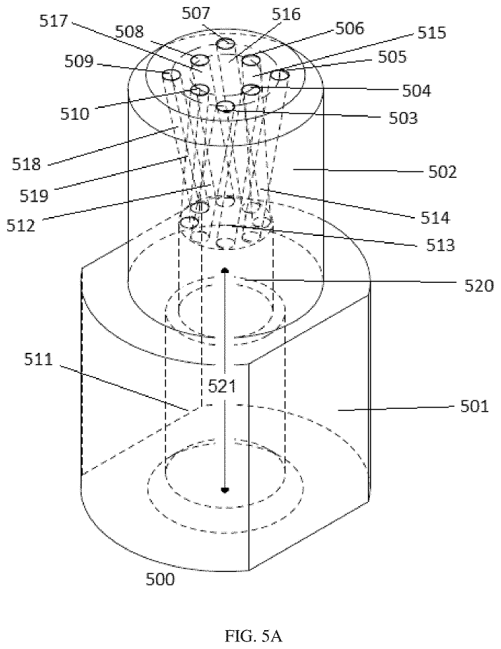

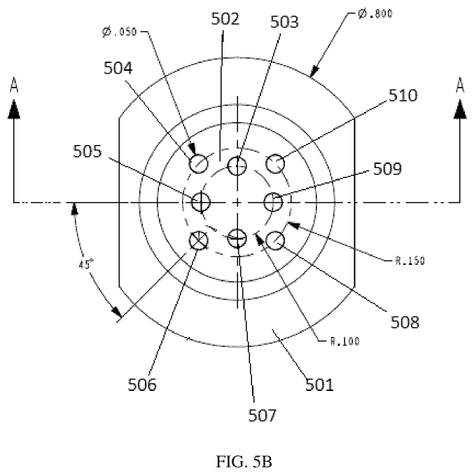

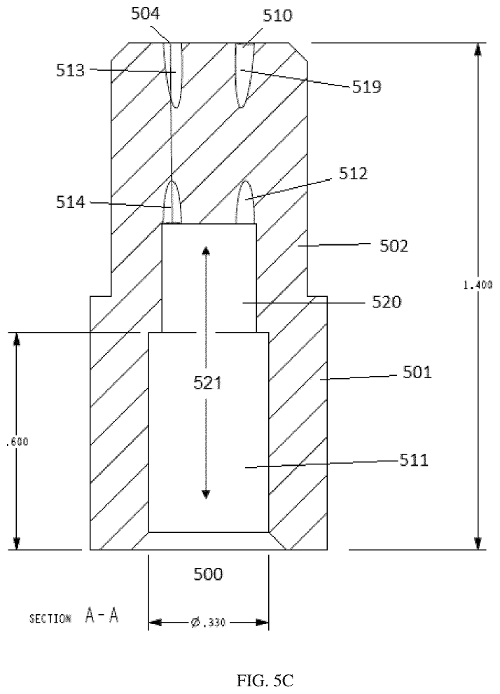

FIG. 5A is a transparent view of the nozzle 500, FIG. 5B is a top view of the nozzle 500, and FIG. 5C is a cross section of the nozzle 500. Similar to the embodiment illustrated in FIGS. 1A-D, the nozzle 500 of FIGS. 5A-C includes eight outlet ports 503, 504, 505, 506, 507, 508, 509, and 510 each fluidly connected to one of eight flow channels 512, 513, 514, 515, 516, 517, 518, and 519, respectively. The flow channels 512, 513, 514, 515, 516, 517, 518, and 519 rotate around a center axis of the nozzle 500 while traversing the nozzle housing from inlet ports to outlet ports 503, 504, 505, 506, 507, 508, 509, and 510 to impart a helical flow on fluid moving through the nozzle 500. The nozzle 500 can include a nozzle housing having a top portion 502 and a bottom portion 501, with the top portion 502 having a smaller interior diameter than the bottom portion 501. However, the bottom portion 501 and top portion 502 can have the same interior diameter in other embodiments. Fluid can enter the nozzle 500 through a fluid inlet connected to a starting end of the nozzle 500 into a first tubular flow path 511. The first tubular flow path 511 and concentric second tubular flow path 520 form an inner tubular flow path 521. From inner tubular flow path 521, fluid can enter the smaller flow channels 512, 513, 514, 515, 516, 517, 518, and 519 before exiting through the outlet ports 503, 504, 505, 506, 507, 508, 509, and 510 at a terminal end of the nozzle 500 into a container (not shown).

As illustrated in FIG. 5B, The outlet ports 503, 504, 505, 506, 507, 508, 509, and 510 are arranged in two concentric circles around a center axis of the nozzle 500, with outlet ports 503, 505, 507, and 509 closer to the center axis than outlet ports 504, 506, 508, and 510. As illustrated in FIG. 5B, outlet ports 503, 505, 507, and 509 can be positioned about 0.100 inches from the center axis, while outlet ports 504, 506, 508, and 510 can be positioned at about 0.150 inches from the center axis. Other arrangements of outlet ports on the terminal end of the nozzle housing can be used, and the outlet ports need not be positioned in concentric circles or at any specific distance from the center axis. The diameter of the outlet ports 503, 504, 505, 506, 507, 508, 509, and 510 is about 0.050 inches, but can be set to any size capable of providing the necessary helical flow. The terminal end of the nozzle housing in FIGS. 5A-C is a substantially flat surface. However, the same arrangement of outlet ports could be used with a dome shaped nozzle.

As illustrated in FIGS. 5C-5D, the bottom portion 501 of the nozzle 500 can form part of a circle having a diameter of about 0.800 inches. The first inner tubular flow path 511 can have a diameter of about 0.330 inches and extend for 0.600 inches, or about 30% of the 1.400 inch height of the nozzle 500. However, other sizes can be used for the nozzle 500, depending on the size of the containers used and the needs of the user

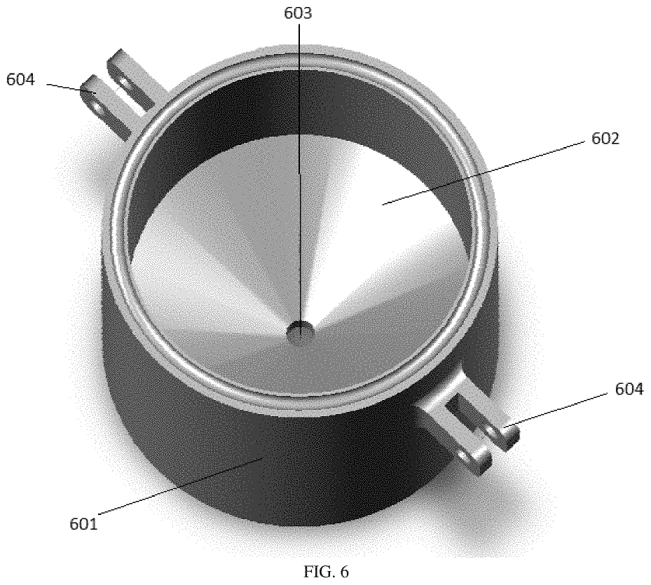

FIG. 6 illustrates a cutaway showing a bottom half of a container 601 that can be connected to the nozzles illustrated in FIGS. 1-5. The container 601 can initially contain a solid or powdered material in an interior 602 of the container 601. The nozzle can be inserted through opening 603 at a bottom of the container 601. The nozzle can connect to the container 601 by any means known in the art that prevents leakage of fluid when moving between the nozzle and container 601. For example, the nozzle can be threaded on an interior or exterior surface. The nozzle can have threads around an exterior or interior of a top portion of the nozzle that can be screwed into corresponding threads around the opening 603 of the container 601. Rotating the nozzle with respect to the container 601 can connect the nozzle and container 601. Alternatively, threads, gaskets, o-rings, or snap connectors can be used. Alternatively, the nozzle can be injection molded to the bottom of the container 601 to provide a permanent connection between the nozzle and container 601. Although shown as rigid container 601 in FIG. 6, the nozzles of the invention can be used with any rigid or flexible container or bag. Latches 604 can be used to secure a top to the container 601.

In another embodiment, one or more nozzles of the invention can be affixed to a bottom surface of a container containing. The plural nozzles can dissolve a large batch of concentrates. The plural nozzles can be spaced in any location on a bottom surface of a container initially containing a concentrate. For example, a large vat can have 2, 3, 4, 5, or more nozzles positioned at any location and at any angle relative to the bottom surface of the vat to provide multiple swirling flows of fluid into the container. The invention is not limited to dialysate generation and can be used to dissolve concentrates for any suitable industrial process.

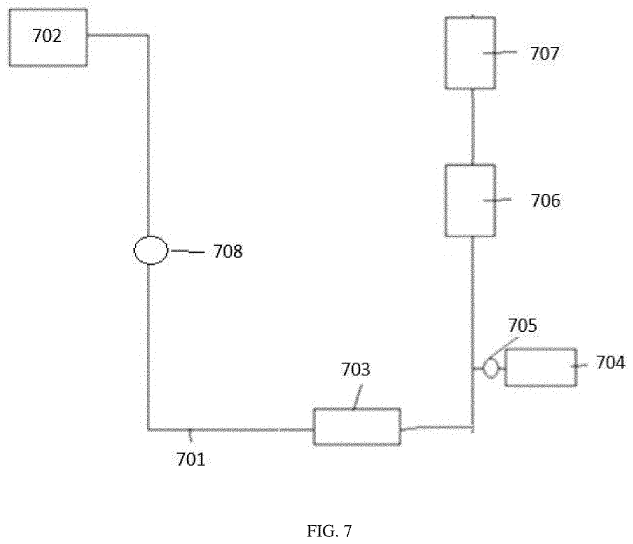

As a non-limiting example, FIG. 7 shows a peritoneal dialysate generation flow path 701 that can use the nozzles described. Peritoneal dialysate contains ions, such as sodium chloride, potassium chloride, calcium chloride, magnesium chloride, buffer, such as bicarbonate, lactate, or acetate, an osmotic agent, such as glucose, or other acids, such as lactic acid. Any ion source can be placed within the containers used with the nozzles of the present invention. Water from a water source 702 can be pumped into the peritoneal dialysate generation flow path 701. System pump 708 can control the movement of fluid through the peritoneal dialysate generation flow path 701. The system pumps the fluid from water source 702 through a water purification module 703 to remove chemical contaminants in the fluid in preparation for creating peritoneal dialysate. Alternatively, peritoneal dialysate grade water can be used instead of water purification module 703. The water purification module 703 can be any component or components capable of removing contaminants from the water in water source 701, including a sorbent cartridge, reverse osmosis module, nanofilter, or combination of ion and anion exchange materials.

Upon passing through water purification module 703, fluid can be pumped to a concentrate source 704 where necessary components for carrying out peritoneal dialysis can be added from the concentrate source 704. The concentrates in the concentrate source 704 are utilized to create a peritoneal dialysis fluid that matches a dialysis prescription. Concentrate pump 705 can control the movement of concentrates from the concentrate source 704 to the peritoneal dialysate generation flow path 701 in a controlled addition. The concentrates added from the concentrate source 704 to the peritoneal dialysate generation flow path 701 can include any component prescribed for use in peritoneal dialysate.

The concentrate source 704 can initially contain a solid material, such as solid glucose, solid sodium chloride, or any other solid source of material used to generate peritoneal dialysate. Water from the water source 701 can be pumped into the concentrate source 704 through the nozzles illustrated in FIGS. 1-5. The nozzle (not shown) creates a helical flow of fluid entering the concentrate source 704, speeding dissolution of the material inside. For generation of peritoneal dialysate, the concentrate solution formed in the concentrate source 704 can be added by concentrate pump 705 to the peritoneal dialysate generation flow path 701 through the same nozzle, or through different conduits. Any number of concentrate sources can be used to generate the peritoneal dialysate. For example, a single concentrate source containing an aqueous concentrate having all components used in peritoneal dialysis can be used. Alternatively, a separate osmotic agent source containing glucose and one or more ion concentrate sources containing the other components of the peritoneal dialy sate can be used. Any number of concentrate sources containing any combination of material can be included.

After addition of the concentrates from concentrate source 704, the fluid can be sterilized in sterilization module 706. Sterilization module 706 can be any component or set of components capable of sterilizing the peritoneal dialysate, including one or more ultrafilters a UV light source, a microbial filter, or any combination thereof. After sterilization of the fluid by the sterilization module 706, the generated peritoneal dialysate can be pumped to a dialysate container 707 for storage until ready for use by a patient.

Although FIG. 7 shows a peritoneal dialysis flow path, the nozzles can also be used in a dialysis flow path for hemodialysis, hemofiltration, hemodiafiltration. Further, the nozzles described can be used for other applications, such as industrial scale bulk solution preparation that uses a flow path without a mechanical mixer. Any system where dissolution of solids or dilution of concentrates in a container is used can include the described nozzles, such as mixing organic solvents and solutes, such as ethanol.

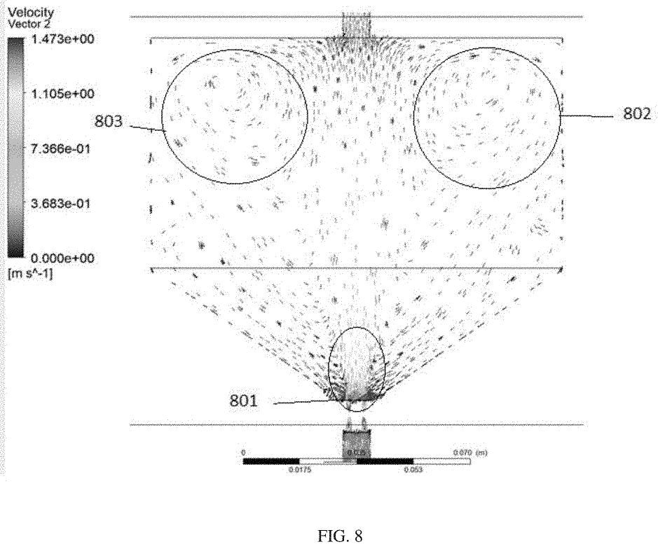

FIGS. 8-11 show flow dynamics computations using the described nozzles. FIG. 8 illustrates velocity distribution of fluid flow through a container using a helical nozzle and was generated using Computational Fluid Dynamics. The legend for FIG. 8 transitions from a high velocity flow in red, to orange, to yellow, to green, to light blue, and then to blue. However, FIG. 8 has been reproduced in grayscale. The model used to generate FIG. 8 uses 300 mL/min inlet flow at 50° C. with steady state conditions and a room temperature of 20° C. Fluid enters the container through a nozzle at the bottom of the container.

The model shows a high velocity flow stream exiting the nozzle in a cylindrical fashion in the portion labeled 801. The model also shows a convection-like pattern towards the top corners of the container in the portions labeled 802 and 803. The convection pattern continues back to the base of the container as the fluid returns to the nozzle flow path at portion 801.

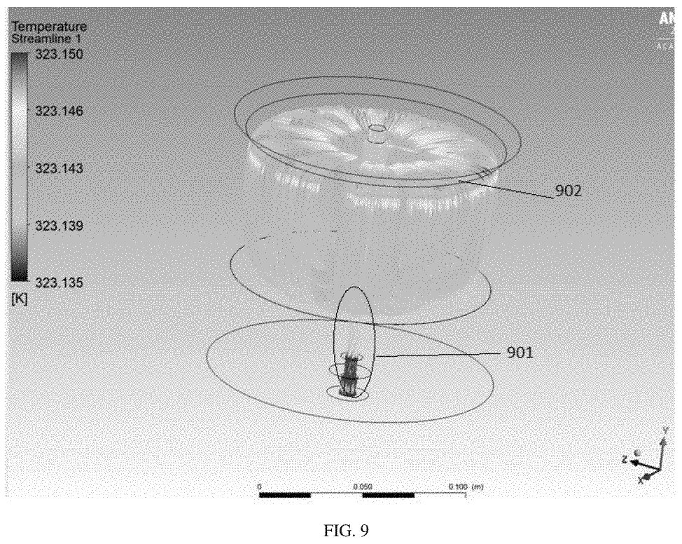

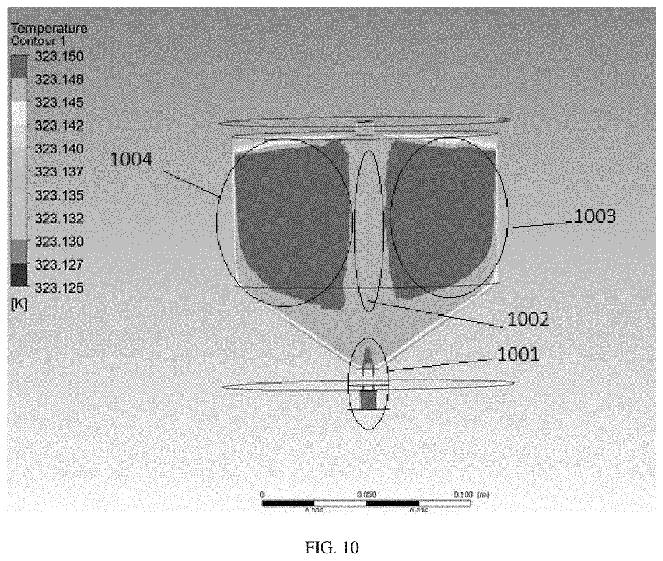

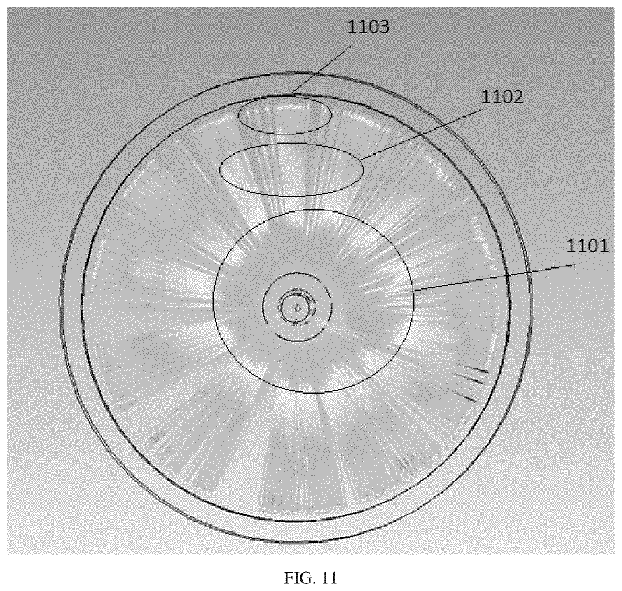

FIGS. 9-11 are Computational Fluid Dynamics models that show temperature distribution of the flow stream in the container using a helical nozzle. The legend in FIGS. 9-11 transitions from a high temperature in red, to orange, to yellow, to green, to light blue, and then to blue. However, FIGS. 9-11 have been reproduced in grayscale. FIG. 9 shows a side view of the container, FIG. 10 shows a cross-sectional view of the container, and FIG. 11 shows a top view of the container. The inlet temperature for the models was set at 50° C.

As shown in FIG. 9, a helical pattern generated as fluid exits the nozzle, shown in portion 901. The fluid moves to the top of the container shown in portion 902, and then back to the base and the nozzle flow path.

As can be seen in FIG. 10, the warmest point in the fluid is at the immediate exit of the nozzle in portion 1001. The fluid immediately cools as the fluid moves up the center of the container in portion 1002. The convection distribution portions 1003 and 1004 are cooler than the fluid at the immediate exit of the nozzle, though the red regions in the upper part of portions 1003 and 1004 suggest that portions 1003 and 1004 are similar to the fluid temperature exiting the nozzle.

FIG. 11 shows the same temperature distribution as in FIG. 9, but with the view from the top of the container. The fluid exiting the nozzle has a helical flow distribution shown in portion 1101. The fluid cools as the fluid moves away from the nozzle flow path in portion 1102. The fluid is cooler near the edges of the container in portion 1103, as the model was designed to assess fluid temperatures as in a 20° C. room temperature environment.

One skilled in the art will understand that various combinations and/or modifications and variations can be made in the described systems and methods depending upon the specific needs for operation. Various aspects disclosed herein may be combined in different combinations than the combinations specifically presented in the description and accompanying drawings. Moreover, features illustrated or described as being part of an aspect of the disclosure may be used in the aspect of the disclosure, either alone or in combination, or follow a preferred arrangement of one or more of the described elements. Depending on the example, certain acts or events of any of the processes or methods described herein may be performed in a different sequence, may be added, merged, or left out altogether (e.g., certain described acts or events may not be necessary to carry out the techniques). In addition, while certain aspects of this disclosure are described as performed by a single module or unit for purposes of clarity, the techniques of this disclosure may be performed by a combination of units or modules associated with, for example, a medical device.

1. A nozzle, comprising:
a nozzle housing having a starting end and a terminal end, wherein the starting end is fluidly connectable to a fluid line;
a plurality of flow channels inside the nozzle housing wherein each of the plurality of flow channels traverses the nozzle housing from an inlet port to an outlet port, wherein the inlet port is fluidly connected to the starting end and the outlet port is in fluidly connected to the terminal end; and
each flow channel rotating around a center axis of the nozzle housing from the inlet port to the outlet port, wherein an angle of difference between the inlet port and outlet port from a top perspective ranges from around 20° to around 70° about the center axis of the nozzle housing.

2. The nozzle of claim 1, wherein the terminal end is a hemispherical dome having one or more elevations around a circumference of the hemispherical dome, wherein two or more outlet ports are positioned at one or more elevations on the hemispherical dome.

3. The nozzle of claim 1, wherein the terminal end has a substantially flat surface, the two or more outlet ports positioned on the substantially flat surface.

4. The nozzle of claim 1, wherein the plurality of flow channels ranges from two to twelve.

5. The nozzle of claim 1, wherein the flow channels rotating around a center axis of the nozzle housing from the inlet port to the outlet port are curved to form a helical flow channel.

6. The nozzle of claim 1, wherein the nozzle housing defines an inner tubular flow path from the starting end to the one or more inlet ports of the flow channels.

7. The nozzle of claim 6, wherein the nozzle housing defines a first tubular flow path and a concentric second tubular flow path distal to the first tubular flow path; wherein a diameter of the second tubular flow path is smaller than the first tubular flow path.

8. The nozzle of claim 1, further comprising a connector for fluid connection to the starting end of the nozzle housing.

9. The nozzle of claim 8, wherein the connector is threaded on an exterior or interior surface.

10. The nozzle of claim 1, wherein the outlet ports on the terminal end are positioned equidistant from the center axis of the nozzle housing.

11. The nozzle of claim 1, wherein at least two of the outlet ports are positioned at different distances from the center axis of the nozzle housing.

12. A system, comprising;
a flow path fluidly connected to a water source;
a fluid line fluidly connecting the starting end of the nozzle housing of claim 1 to the flow path; and
a concentrate source fluidly connected to the nozzle housing.

13. The system of claim 12, wherein the concentrate source contains a solid.

14. The system of claim 12, wherein the flow path from the nozzle housing is further fluidly connected to a dialysate container.

15. The system of claim 12, wherein the flow path is a peritoneal dialysate flow path.

16. The system of claim 12, wherein the concentrate source is selected from the group consisting of any one of solid glucose, solid bicarbonate, solid sodium chloride, solid potassium chloride, solid magnesium chloride, solid calcium chloride, lactic acid, and combinations thereof.

17. The system of claim 12, further comprising one or more nozzles of claim 1 affixed to a bottom surface of a container containing one or more concentrate source.

18. A method using the system of claim 12, comprising the steps of:
pumping water from the water source through the starting end of the nozzle housing into the concentrate source;
dissolving a solid or powdered substance in the concentrate source to generate a concentrate or diluting a concentrate to a new concentration; and
pumping the concentrate into the flow path.

19. The method of claim 18, wherein the flow path is part of a dialysis flow path.

20. The method of claim 18, wherein the flow path is part of a peritoneal dialysis flow path.

21-22. (canceled)
